(19) United States
(12) Patent Application Publication
(10) Pub. No.: US 2004/0181530 A1
(43) Pub. Date: Sep. 16, 2004

(54) Distributed networking system for resource-constrained computing devices

(76) Inventors: Lawrence T. Smith, Alberta (CA); Cameron Roe, Alberta (CA); K. Steven Knudsen, Alberta (CA)

Correspondence Address: ANTHONY MIELE, PALMER & DODGE, LLP, 111 HUNTINGTON AVENUE, BOSTON, MA, 02199, US

(21) Appl. No.: 10/483,209

(22) PCT Filed: Aug. 29, 2002
(86) PCT No.: PCT/CA02/01375

(51) Int. Cl. G06F 17/30

(52) U.S. Cl. 707/9

(57) ABSTRACT

A host computer provides at least one network client with access to at least one network service in a distributed computing environment includes a data processing system that is configured to provide the network clients with access by transmitting lookup service interface means to the network clients. The host computer includes a lookup service which has information associated with each network service. The lookup service means is “self-contained”, in that it includes a reference to the network service sufficient to allow the network client to communicate with the network service. The lookup service interface means comprises a non-proxy interface object that is configured to facilitate non-proxy communication with the lookup service.

### FIELD OF THE INVENTION

The present invention relates to a distributed networking environment. In particular, the present invention relates to a method and a system for facilitating communication by resource-constrained computing devices.

### BACKGROUND OF THE INVENTION

Technologies such as Jini (Jini is a trademark of Sun Microsystems Inc.), RMI (RMI is a trademark of Sun Microsystems Inc.), Universal Plug and Play (UPnP) [1][2][3][4], and others, purport to support the distribution of software-defined services and information in communications networks.

The roots of these technologies are now well known in the art. The first multi-user computer systems required users to physically present their programs for input and execution by the central computer. Centralized, large computer complexes commonly used. From that time to the present, there has been an evolution of computing, driven largely by the logarithmic declines in the cost and size of computing devices—an evolution that continues.

Today, social acceptance of computer technology has reached the point that a person owns and operates multiple computing devices. These devices are present ill the immediate environment and/or are mobile—e.g., travelling with the person to provide services and information.

An immediate result of distributed, mobile computing is that access to computing resources is variable in cost and complexity over time and space[1], which is to say, inter alia, one or more of the following:

Networks are unreliable; connections to other computers may disappear unexpectedly.

The latency of a network is variable. Delays in sending and receiving information are dependent on factors such as the physical medium, traffic on the network, and information routing algorithms.

Bandwidth is not constant. Like latency, there is often no guarantee of transmission capacity availability.

Networks are insecure. This is especially true of heterogeneous networks wherein the devices exchanging information cannot control the route that information takes.

Network topologies are variable. This is most obvious in mobile networks when devices move between network access points. In the future, multi-mode devices will move between network types (e.g., from a cellular network to a wireless local area network to a wired desktop network).

Administration of net-works is not uniform. Multiple networks mean multiple sets of rules, protocols, access, authorization, and security protocols, all controlled by disparate organizations and individuals. Accessing and securing resources across these networks is complicated by inconsistent administration practices.

Access and transportation costs are variable.

Jini network technology [1] purports to address these problems by defining mechanisms to support the federation of machines or programs into a single, dynamic distributed system. Devices participating in such a system call enter and leave at will, can tolerate network and system variability (as described above), can offer “services” and resources to other devices and systems in the federation. In the context of this specification, a “service” refers to an entity that can be used by a person, group of people, organization, program or other service. The “service” can be anything that can be offered by a computational, networked device, including access to a network, computation, storage, information, access to hardware (such as a printer, modem, etc.) or another user.

Furthermore, devices are able to discover and utilize the “services” provided by members of the federation. This is accomplished through protocol definitions that support network transactions via six primary mechanisms [1][2], as follows:

1. Lookup. This is a set of protocols and interfaces that define a Jini Lookup Service [1]. This is a service that maps interfaces indicating the functionality offered by a service to sets of objects that implement the service. As is known in the art, an “object” is a software program or subprogram that can be executed (run) on one or more devices in the federation. In general, Jini services employ objects based on Java, and can run on any devices that support a Java Virtual Machine (JVM). Associated with the service are descriptive entries that allow for the selection of services based on properties understandable by one or more entities in the Jini federation. Objects in a Lookup Service may contain other Lookup Services, allowing for a hierarchical structure. Users (clients) of a Lookup Service may add new services, dynamically extending the functionality of the federation.

2. Discovery. The process of finding a suitable Lookup Service is referred to as Discovery. Lookup Services listen for and respond to requests for Lookup Services. Alternatively, a Lookup Service may announce its presence on the network via a broadcast message. A client device may use the announcement to locate and utilize a suitable Lookup Service.

3. Join. Once found a Lookup Service has been found, a client device may join its service(s) to that Lookup Service by providing one or more objects. The Join protocol defines the mechanism to accomplish this.

4. Leasing. The use of a resource, granted for a specific amount of time, is known as a lease. The duration of the lease may be fixed by the grantor, or negotiated. To maintain it, the lease must be renewed periodically. This allows for the expiration and cleanup of services that are no longer required, or whose owners have left the federation. Thus, leasing helps manage interactions between devices in a variable network environment.

5. Transactions. A transaction refers to the mechanism used to ensure that service operations are consistent and complete within the federation. That is, a transaction allows a set of operations to be grouped in such a way that they either all succeed or all fail. To members of the federation, the operations in the set appear to occur simultaneously. By utilizing transactions, consistency over a set of operations on one or more remote participants can be enforced. If all the participants are members of a transaction, one response to a remote failure is to abort the transaction, thereby ensuring that no partial results are written.

6. Events. An object residing on a device may register an interest in an event occurring in another object residing on a different device in the federation and receive notification when the event occurs. Thus, events provide a mechanism for maintaining consistency of state (information) in the federation.

Using Jini, devices can spontaneously form federations (network communities) through the Discovery and Join protocols. The only requirement for devices is that they host a suitable Java Virtual Machine (JVM) and can communicate. A Unified Modelling Language (UML) depiction of such a device is shown in FIG. 1. When a device using Discovery and Join connects to one or more other devices to form a network, the device polls the network for a Jini Lookup Service. The device then registers itself with the Lookup Service. Alternatively, the device may itself already host a Lookup Service, which then becomes available to (discoverable by) other devices in the network. Devices in the network may query the Lookup Services they have discovered to determine whether desired services are available. Desired services can be downloaded and executed locally by a device. Because this process is automatic, devices (and hence, users) need not perform complicated installation procedures to couple Jini-enabled devices to the network and enable the devices to function cooperatively with other devices on network.

In the reference implementation of Jini, Suni Microsystems has employed its Remote Method Invocation (RMI) technology [3]. The primary Lookup Service behavior is defined by the ServiceRegistrar interface which is implemented as an PI proxy. When a client device needs to use the Lookup Service, it downloads the ServiceRegistrar object. Execution of ServiceRegistrar methods is done via the proxy that makes RMI calls back to the device originating the service. This is illustrated in FIG. 2.

As shown therein, both client devices discover the Lookup Service and each obtains a ServiceRegistrar object. The device on the right side of the diagram registers for event notification using its ServiceRegistrar, which uses an R proxy call back (indicated as RMI.notify) to the Lookup Service. The Lookup Service sends event notifications directly to the device. The device on the left side of the diagram joins the Lookup Service (i.e., registers a service using its ServiceRegistrar, which uses an SEMI proxy call back, RMI.register, to the Lookup Service). Some time later, the device on the right receives a RemoteEvent message concerning the service recently registered with the Lookup Service.

The use of RMI is convenient in that Jini is itself an extension of some of the fundamentals behind RMI and the problems that RMI purports to obviate or mitigate. However, the resulting Jini Lookup Service implementation is large (e.g., typically, over 2 megabytes of static Java bytecode) because it must support the RMI protocol to satisfy RMI proxy objects such as the ServiceRegistrar. Such Jini network technology implementations are too large to be hosted by low-cost, memory-constrained embedded computing devices that are currently prevalent in the art.

Thus, despite the advances in the art of implementation of Jini technology, there is still room for improvement, particularly in the area of implementing lookup service technology in resource- and/or memory-constrained computing devices.

### SUMMARY OF THE INVENTION

According to a first aspect of the present invention, there is provided a host computer that provides at least one network client with access to at least one network service in a distributed computing environment. The host computer includes a data processing system that is configured to provide the network clients with access by transmitting lookup service interface means to the network clients. The lookup service means is “self-contained”, in that it includes a reference to the network service sufficient to allow the network client to communicate with the network service.

According to a second aspect of the present invention, there is provided a method for providing at least one network client with access to at least one network service in a distributed computing environment, the method comprising the steps of (1) receiving at a host computer an access request to a lookup service from the network client; and (2) transmitting lookup service interface means to the network client, the lookup service means including a reference to the network service.

According to a third aspect of the present invention, there is provided a computer-readable medium including processing instructions for a general-purpose computer. The processing instructions define in the computer a data processing system for interfacing the computer with a network. The data processing system is configured to transmit lookup service interface means over the network to at least one network client. The lookup service means includes a reference to at least one network service available over the network.

According to a fourth aspect of the present invention, there is provided an electronic signal that defines lookup service interface means in a client computer that interfaces with a computer network. The lookup service means including a reference to at least one network service available over the network.

According to a fifth aspect of the present invention, there is provided a host computer that provides at least one network client with access to at least one network service in a distributed computing environment. The host computer comprises a data processing system which has a lookup service including information associated with the at least one network service. The data processing system is configured to transmit lookup service interface means to the network client. The lookup service means comprises an interface object that is configured to facilitate non-proxy communication with the lookup service.

According to a sixth aspect of the present invention, there is provided a method for providing at least one network, client with access to at least one network service in a distributed computing environment, the method comprising the steps of (1) receiving at a host computer an access request to a lookup service from the network client, the host computer including a lookup service comprising information associated with the network service; and (2) transmitting lookup service interface means to the network client, the lookup service means being configured for non-proxy communication with the lookup service.

In one implementation of the invention, the data processing system includes a lookup service (hereafter referred to as a LUS for differentiation from other lookup service implementations) that comprises information associated with each network service. The LUS implements at least one of the Lookup Service functions consistent with a Jini Lookup Service host, as defined in the Jini technology specification [1]. Preferably, the data processing system implements the LUS using non-Java programming languages, although in one variation the data processing system implements the LUS using a Java Virtual Machine.

The lookup service interface means (hereinafter referred to as a ServiceRegistrar software object) comprises a non-proxy interface object that is configured to facilitate non-proxy communication with the LUS. Also, the data processing system is configured to transmit the ServiceRegistrar software object to the network client using a non-RMI protocol.

In another of its aspects, the present invention provides a Host computing device comprising a memory, a data communication means, an operating system, the memory comprising instructions for: (i) exporting a pre-marshalled, non-proxy, self-contained ServiceRegistrar software object that implements a ServiceRegistrar interface and ServiceRegistrar behavior (as defined in the Jini technology specification [1]), (ii) hosting a LUS compatible with the a non-proxy, self-contained ServiceRegistrar software object and consistent with a Jini Lookup Service host as defined in the Jini technology specification [1], and (iii) utilizing the data communications means to transfer the non-proxy, self-contained ServiceRegistrar software object to a second computing device. In this aspect the computing device does not use Java or support a Java Virtual Machine. It does, however, offer Java software based services and accepts the registration of Java software based services. These services reside on the device in a pre-marshalled form, having been prepared by a separate computing device similar to a Client computing device or a Client device itself (i.e., a device that supports a suitable JVM Such a client device is shown in FIG. 5. The depicted Client computing device that can acquire and use services or may offer zero or more services. The hardware device is associated with an operating system. The operating system may be only a state machine or something more complex. The Java virtual machine depends on the operating system. The data communications transceiver supports wired or wireless media.

The term Host computing device refers to the device that hosts the LUS. It offers the ServiceRegistrar software object and other services that have been registered with the LUS. The LUS program or subprograms may be implemented using Java on the Host device, or instead may be implemented using a non-Java programing language or languages on the Host device.

The term Client computing device refers to any device that can participate in a Jini federation. No specific claims related to the client device are made. It is required in this description to illustrate the functions of the Host device and the software design approach employed to support the functions of the LUS.

An advantage of the present invention is that it obviates or mitigates the problem of implementing Lookup Service functionality on a memory-constrained computing device. The other primary mechanisms described above are unchanged and thus, it is not necessary to describe them in great detail here. More information may be obtained from the references listed herein, which are hereby incorporated by reference.

A further advantage of the present invention is that it avoids the use of proxy objects in the implementation of the LUS ServiceRegistrar interface. Instead of utilizing a proxy software object to implement the ServiceRegistrar interface [1] and having the proxy invoke ServiceRegistrar methods via a proxy protocol, a non-proxy ServiceRegistrar software object is offered by the LUS. That is, the ServiceRegistrar interface is realized using, a self-contained software object that implements the interface and its behavior on the requesting device. The ServiceRegistrar object relies on the Java Virtual Machine of the client device on which it has been instantiated. It uses that JVM and its supporting subprograms (contained in general in ancillary Java class files) to perform all Java-dependent operations required by the LUS. The primary such operation is the marshalling of new service items in response to register requests, and the unmarshalling of service items retrieved from the LUS. Unmarshalled service items become Java software objects when loaded by the Client's JVM. Thus, the JVM of the client device is required to support class loading and serialization as indicated in FIG. 1.

Preferably, all information and services required to satisfy the ServiceRegistrar interface are maintained on the requesting device, including, for example, registered services, group information, and event registration. To maintain consistency within the federation, when instantiated on the client device the ServiceRegistrar software object communicates changes in its state to the LUS program or subprograms on the Host device. In turn, the LUS program or subprograms notify other devices possessing ServiceRegistrar objects obtained from the LUS. This behavior is illustrated in the general case in FIG. 7 and for a specific state change in FIG. 8.

Also, preferably the LUS program or subprograms maintain persistently on the Host device all state information relevant and common to all ServiceRegistrar software objects it has granted to requesting Client devices. Changes in state information are communicated to the objects. For example, if an administrator changes the groups associated with the LUS, that change is communicated to all ServiceRegistrar software objects. Temporary or transient state and other information may be maintained in the ServiceRegistrar objects instantiated on the Client devices. Provision is made to synchronize that information with the information stored on the Host device or other Client devices. This is accomplished via prescribed messages passed between the ServiceRegistrar and one or more subprograms on the Host device.

Implementing the LUS and ServiceRegistrar in this way results in a compact, efficient LUS suitable for use by small, resource-constrained devices.

### BRIEF DESCRIPTION OF THE DRAWINGS

Embodiments of the present invention are described herein with reference to the accompanying drawings, in which:

In FIG. 1, a Unified Modelling Language representation of a computing device capable of participating in a federation is shown;

FIG. 2 is an illustration of the operation of an RMI-based Jini Lookup Service;

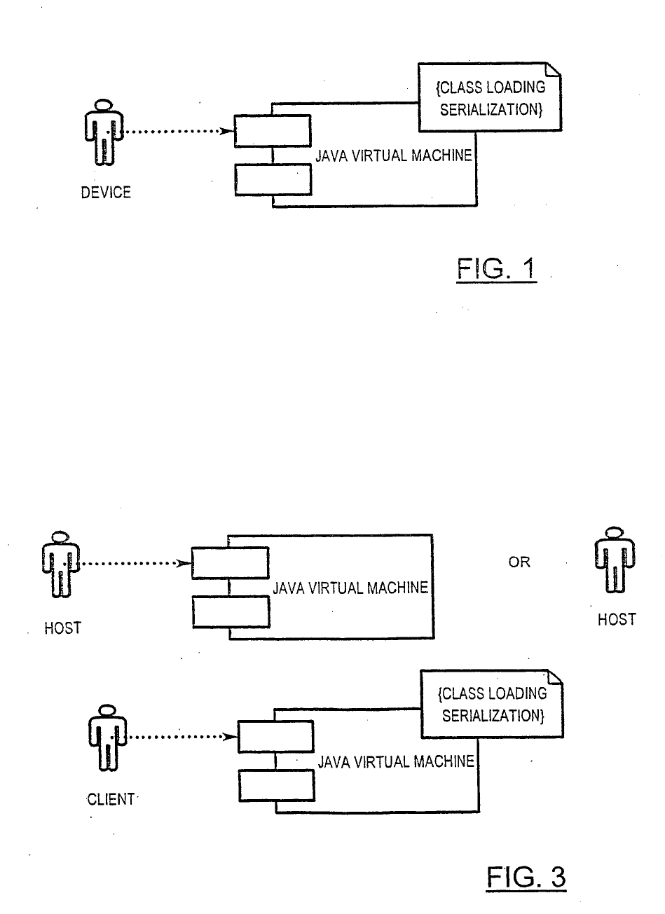

FIG. 3, represents the Host and Client computing devices with the UML actors;

FIGS. 4 and 5, respectively are deployment diagrams of the preferred embodiments of the Host and Client devices;

FIG. 6 is an illustration of the ServiceRegistrar interface definition including the required operations;

FIG. 7 illustrates the maintenance of state information by a ServiceRegistrar object, using the Event mechanism as an example; and

FIG. 8 depicts the operation of a non-RMI-based LUS.

### DETAILED DESCRIPTION OF THE PREFERRED EMBODIMENTS

As will be appreciated by those of skill in the art, various of the drawings of this specification are presented for the purposes of illustrating a preferred embodiment of the present invention only, and not for the purposes of limiting the same.

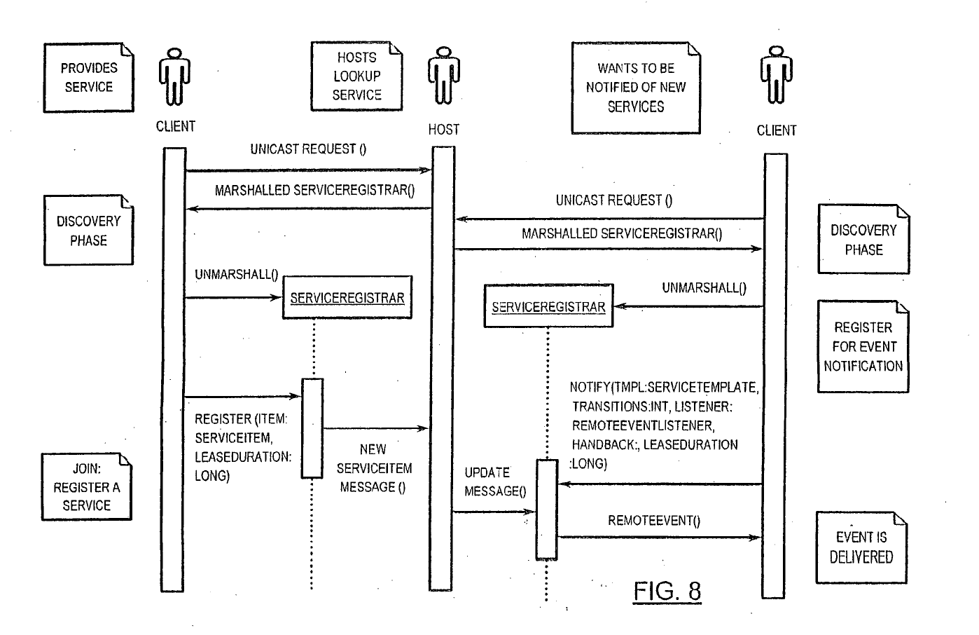

In FIG. 8, an interaction is illustrated between a computing device (hereafter referred to as a Host) that hosts a Lookup Service (hereinafter referred to as a ‘LUS’) according to the present invention, and two client computing devices. The LUS employs a non-RMI-based ServiceRegistrar implementation. Both devices discover the LUS and each obtains a ServiceRegistrar object. The device on the right side of the diagram registers locally for event notification using its ServiceRegistrar. The device on the left side of the diagram joins the LUS using its local ServiceRegistrar, which sends a message to the LUS indicating the new service. Since the device on the right has registered for event notifications, the LUS sends it a message with the details of the newly registered Service provided by the device on the left. The device on the right then downloads the service to use on its local JVM.

The LUS programs or subprograms support all Jini network technology Lookup Service mechanisms as required by the Jini specification [1].

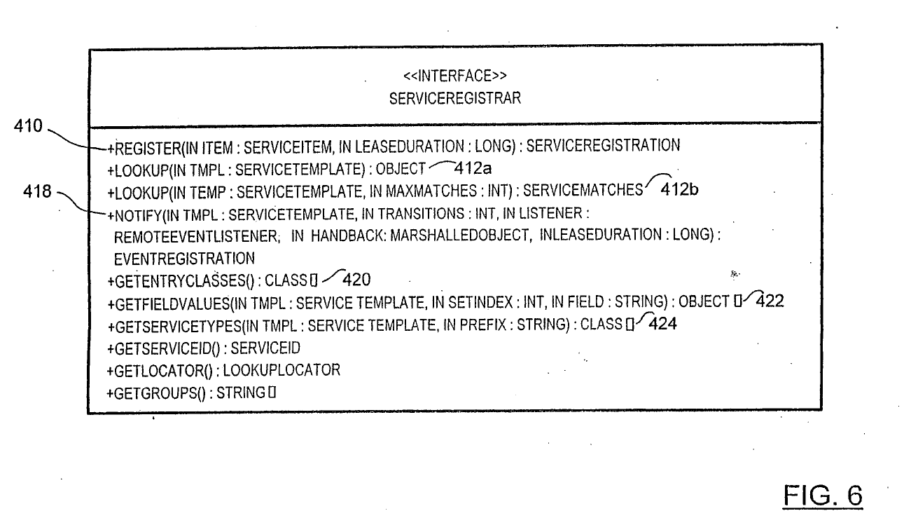

The ServiceRegistrar, according to the present invention, is implemented as a self-contained Java software object. For each public method (i.e., method of the ServiceRegistrar object that can be invoked by a client device; see FIG. 6), many of the computations related to the ServiceRegistrar and LUS functions are done on the local, client computing device. All Java-dependent operations required to fulfill the requirements of the LUS implementation are executed by the Service Registrar object on the Client device. The two main operations are class loading and serialization (marshalling and unmarshalling of service items). Likewise, as much as possible, data related to the ServiceRegistrar object and its methods is kept on the local, client, computing device. That is, the ServiceRegistrar does as much as possible on the local, client, computing device. This separation of the Java-dependent functions from the non-Java functions required to implement the LUS allows the programs and subprograms to be implemented using Java or non-Java languages on the Host device. It also results in a significant reduction of the demands upon and, hence, computation and storage requirement of the Host computing device.

The ServiceRegistrar software object, as implemented in this invention, encapsulates much of the LUS functionality and, thus, supports the ability of a Host computing device to act as a LUS. The ServiceRegistrar software object contains a reference to each service offered by the Host. This reference is sufficient to allow a client to acquire the service via the ServiceRegistrar. As part of the discovery mechanism, the Host computing devices marshals a ServiceRegistrar object (flattens, serializes, and packages into a byte array for transport according to the RMI specification [3]) before sending it to a client computing device.

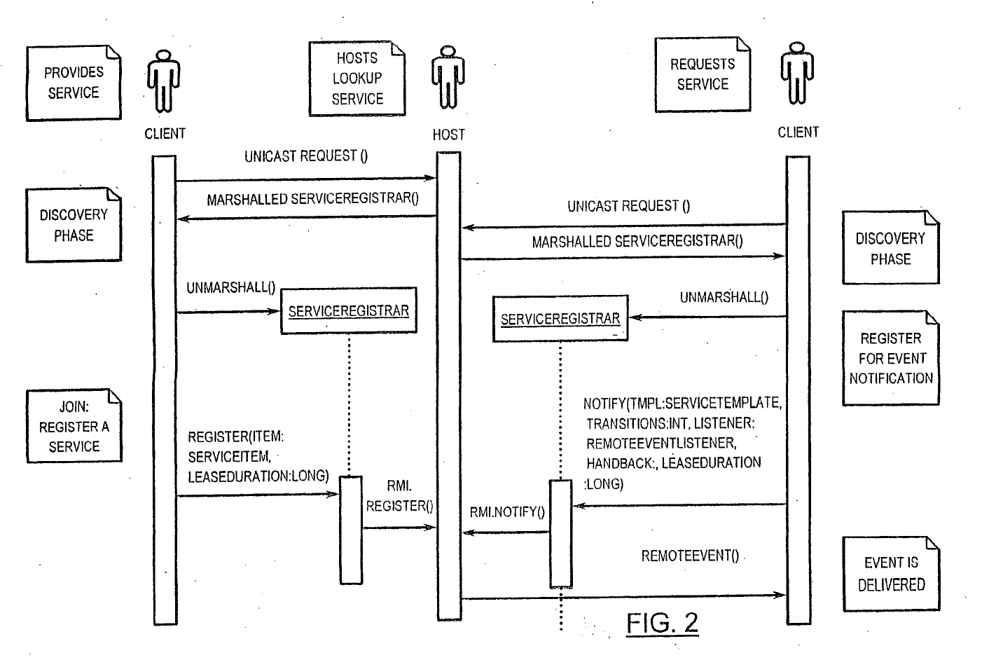

FIG. 3 depicts the UML actors representing the Host and Client computing devices. Although the client must have a Java Virtual Machine that supports class loading and serialization, the Host may have a Java Virtual Machine or may not. When the Host does not support a JVM, the ServiceRegistrar is pre-marshalled and stored on the Host at some previous point in time (for example, at the time the Host was assembled). The preparation (marshalling) of the ServiceRegistrar is accomplished using a computing device similar to a Client device (i.e., that supports a suitable JVM). An example of such a device is a commercial personal computer supporting a recent JVM from Sun Microsystems. A simple marshalling program can be constructed using Sun's Jini technology implementation running on that platform.

To use the ServiceRegistrar, the client unmarshals the received byte array and unmarshals locally the ServiceRegistrar software object. The ServiceRegistrar object maintains a communications link back to the Host. Both sides use the link to maintain state information, manage events, and satisfy service requests and inquiries. In one embodiment, this communications link is a TCP/IP socket connection as supported by standard Java networking technology.

In general, actions performed by the ServiceRegistrar object that result in a change of state either locally or with respect to the federation, will result in communication to the LUS. For example, the LUS is changed if a client registers a service with it using its local ServiceRegistrar object. This is illustrated in FIG. 8 where one client device, having requested notification of new services, is notified of a new service when it is registered by another client device. The act of service registration results in a message being sent to the LUS by the registering client's local ServiceRegistrar object. The message includes the new service software object and other pertinent information. The LUS decodes the message and adds the new service to its local storage. Then the LUS notifies all client devices that have registered (via the ServiceRegistrar notify method) for new service events by sending a message to the clients' local ServiceRegistrar objects. All data structures, state machines, communication protocols, and subprograms required to maintain the state of the LUS are implemented in the ServiceRegistrar object and by software on the Host computing device in so far as required to meet the Jini technology specification [1].

It should be noted that while the implementation of the LUS and ServiceRegistrar does not rely on RMI, services registered with the LUS are free to employ RMI. That is, services may be implemented as RMI proxy objects. This is possible since the LUS as implemented in this invention, does not unmarshal registered services on the Host device or within the ServiceRegistrar objects on client devices. Client devices supplying RMI-based services either implement RMI host software or redirect service requests to a suitable secondary device. Likewise, client devices that use RMI-based services locally must implement RMI client software.

By implementing significant portions of the LUS functions in the ServiceRegistrar objects that are local to client computing devices, the LUS is effectively distributed across the Host and client devices. This has several advantages when the devices involved are small, resource-constrained computers, including a reduction of computational and storage requirements, lower power consumption, and reduced physical size. This approach is well suited to devices that are simple in nature and function, and that need only to supply a simple service for use by other computing devices. For example, a temperature sensor will need only to provide a service that allows a client to request a temperature measurement. The sensor has little interest in hosting services other than its own. This invention allows small devices, such as sensors, to host their own services primarily because the LUS implementation is small and, hence, cost-effective.

The ServiceRegistrar object includes the Service Item object for each service registered with the LUS. Each Service Item object identifies for each service a serviceID, a service element, and an attribute set. The serviceID is a numerical identifier that uniquely identifies the associated service. The service element can either be an object that represents the associated service, or a proxy that facilitates access to the service. The attribute set is a collection of attributes identified properties associated with the service.

The ServiceRegistrar object also provides the methods defined for a ServiceRegistrar object, as described in the Jini specification. As shown in FIG. 6, the ServiceRegistrar object provides methods to (1) register services with the LUS, (2) locate services that match a template, (3) modify attributes values for existing services, (4) receive notifications when services are modified, and (5) query the collection of services according to class, attribute value and type.

The ServiceRegistrar object implements a “register” method 410 to register services with the LUS. To register a new service, the “register” method 410 is invoked, carrying the, Service Item of the associated service as an argument, and with the ServiceID of the Service Item object being set to zero. The register method 410 queries the Service Item objects included with the ServiceRegistrar objects against the service element of the passed Service Item.

If the service element of the passed Service Item does not match the service element of any Service Item already registered, the new Service Item is added to the ServiceRegistrar object, with a new unique value being assigned to the ServiceID. On the other hand, if the service element of the passed Service Item matches the service element of any Service Item already registered, the passed Service Item replaces the existing Service Item in the ServiceRegistrar object. In either case, the register method then notifies the LUS of the change.

To re-register an existing service, the “register” method 410 is invoked, carrying the Service Item of the associated service as an argument, but with the ServiceID of the Service Item object being set to the value returned upon initial registration. As above, the passed Service Item replaces the existing Service Item in the ServiceRegistrar object. The register method 410 then notifies the LUS.

The ServiceRegistrar object implements two “lookup” methods 412 to locate the Service Item objects that match a template. One “lookup” method (the single parameter lookup method 412a) returns the service element of the matching Service Item. The other “lookup” method (the two parameter lookup method 412b) returns the number of matching Service Item objects (at most ‘MaxMatches’ items). In each case, the lookup method 412 queries the Service Item objects included with the ServiceRegistrar object to satisfy the lookup request.

The ServiceRegistrar object implements a “notify” method 418 which allows a client terminal to register with the LUS for notification that, for instance, a Service Item object registered with the LUS has been changed, or if a Service Item has been removed. At a minimum, the notify method 418 is configured to request that the LUS notify the requesting client terminal that any of the following events have occurred: (1) the changed Service Item matches the template before the notify request, but does not match the template afterwards; (2) the changed Service Item 402 does not match the template before the notify request, but does match the template afterwards; and (3) the changed Service Item 402 matches the template both before and after the notify request. As will be apparent, the ServiceRegistrar object notifies the LUS of the desired template and transition combination.

The ServiceRegistrar object implements a “getEntryClasses” method 420 to return the set of classes of the Service Item objects that match a specified template. The ServiceRegistrar object implements a “getFieldValue” method 422 to return the values of the Service Item objects that match a specified template. The ServiceRegistrar object implements a 37 getServiceTypes” method 424 to return the set of types of the Service Item objects that match a specified template. In each case, the method queries the Service Item objects included with the ServiceRegistrar object to satisfy the request.

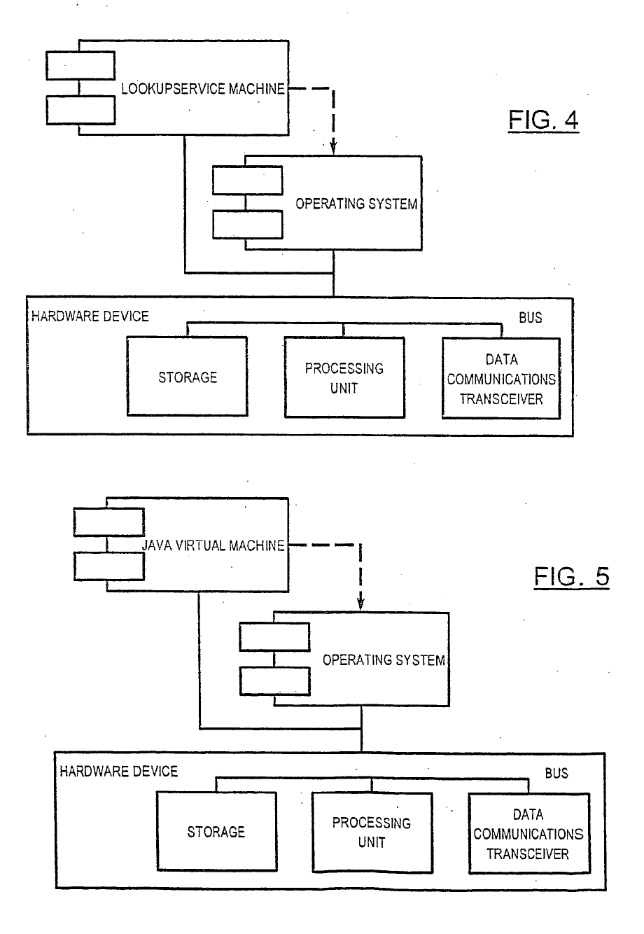

An example Host computing device constructed to host the LUS and its associated services is illustrated in FIG. 4. The Host computing device is a general-purpose computer having a processing unit, an operating system and memory. The processing unit is a small, low-power microprocessor or microcontroller capable of hosting an operating system (real-time or not). The LUS state machine is realized using a non-Java programming language. Although not shown (and hence not essential), Java may be employed to realize the LUS state machine. In this case; the operating system hosts a Java Virtual Machine. The JVM version is able to support the LUS machine implementation; typically this is at least a Java 2 Microedition (J2ME)-level JVM. Application programs written in Java aye executed by the system. The operating system may be separate from the JVM or may be integral.

The processing unit is physically coupled via a standard data bus to) the memory, which may comprise a limited amount of static or dynamic electronic data storage, such as static random access memory (SRAM), dynamic random access memory (DRAM), erasable programmable read-only memory (EPROM) and the like.

The processing unit is physically coupled via a standard communications interface such as a parallel or serial data bus to a wireless communications transceiver. The transceiver supports a standard wireless protocol such as Bluetooth or IEEE 802.11. The wireless protocol is capable of transporting Internet Protocol packets. The transceiver is the main means of data communications for the unit. Secondary communications may be provided by other interfaces, such as Ethernet or RS232.

Preferably, the present invention is implemented in the device disclosed in copending patent application Ser. No. 09/666,880 filed Sep. 20, 2000 by the present inventors.

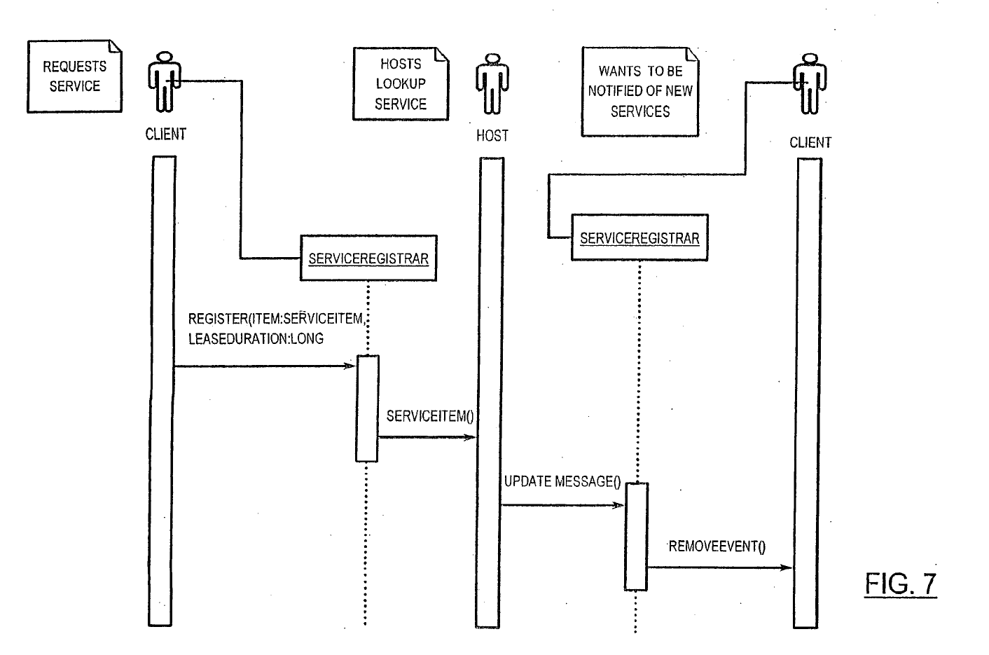

A series of operations involving one or more of the Host computing devices shown in FIG. 7, and network clients will now be described in the following discussion, it is assumed that the Host computing devices are available to the network clients over a network, such as the Internet, the LUS is maintained in the memory of the Host computing device, and the network clients include a processing unit and a memory, for receiving and executed the methods implemented in the ServiceRegistrar object.

Initially, the network client initiates a discover operation for the LUSs by transmitting over the network a user datagram protocol (UDP)-based message using a multicast request protocol, requesting a response from all available LUSs. If the Host computing device satisfies the criteria specified in the message, the Host computing device responds to the network client with a unicast response containing the ServiceRegistrar object. As will be apparent, the discovering network client may receive multiple ServiceRegistrar objects, one for each respective LUS.

As discussed above, the ServiceRegistrar includes the Service Item object for each network resource registered with the LUS. Consequently, using the ServiceRegistrar the network client is able to access the network services registered with the LUS, without further communication with the Host computing device, by invoking the lookup method 412 of the ServiceRegistrar object.

Preferably, the Host computing device serializes the ServiceRegistrar 400 from the information contained in the LUS, and then transmits the serialized object to the network client. Upon receipt, the discovering network client unmarshalls the serialized ServiceRegistrar object. Alternately, serialization of the ServiceRegistrar object may be performed offline by another computing device, with the serialized ServiceRegistrar object being stored on the Host computing device. This latter variation is particularly advantageous since it reduces the resource requirements of the Host computing device further, and would allow the Host computing device to be implemented, for instance, as a state machine rather than as a general-purpose computer.

Subsequently, the networked client may wish to update the ServiceRegistrar object(s) that it has received. If so, the network client initiates another discover operation by establishing a TCP/IP connection with one of the Host computing devices, and then transmitting over the TCP channel a unicast request message. The Host computing device responds to the network client with a unicast response containing the ServiceRegistrar object.

The network client may also wish to register its services with one or more of the LUSs. If so, the network client initiates a join operation by invoking the register method 410 of the ServiceRegistrar object. If register method 410 is successful, the ServiceRegistrar object notifies the Host computing device of the new service, by serializing the Service Item object for the new service and then transmitting the serialized object to the Host computing device. Upon receipt, the Host computing device does not unmarshall the serialized object, but instead stores the object in memory. As will be appreciated, by serializing the Service Item object locally on the network client, and by relieving the Host computing device from unmarshalling Service Items objects, the resource requirements of the Host computing device are reduced further.

The network client may also wish to register for event notification of a change to the LUSs. If so, the network client initiates an event operation by invoking the notify method 418 of the ServiceRegistrar object. Upon completion of the notify method 418, the ServiceRegistrar object notifies the LUS of the notification parameters. Subsequently, if the LUS detects that the specified template and transition combination has occurred, the LUS notifies the ServiceRegistrar object of each network client registered for the specified template and transition.

The Event mechanism as implemented in the invention is further illustrated in FIG. 7. A change in the state of a ServiceRegistrar object owned by the device on the left is caused by the registration of a new service. The ServiceRegistrar object owned by the device sends a message to the LUS hosted by the middle device) indicating that a ServiceItem has been added. The LUS sends an update to all other devices that have registered for notifications, namely, the device on the right.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein (including all documents set out in the List of References section) are incorporated by reference in their entirety to the same extent as if each individual publication, patent or patent application was specifically and individually indicated to be incorporated by reference in its entirety.

### List of References

[1] K. Arnold, et al, The Jini Specification, Reading, Mass.: Addison-Wesley, 1999.

[2] W. K. Edwards, Core Jini, Upper Saddle River, N.J.: Prentice-Hall 2001;

[3] Sun Microsystems Inc., The Remote Method Invocation Specification, 2001.

[4] www.upnp.org/resources.htm

We claim:

1. A host computer for providing at least one network client with access to at least one network service in a distributed computing environment, the host computer comprising:
a network interface for interfacing the host computer with the network; and
a data processing system in communication with the network interface; the data processing system being configured to transmit lookup service interface means to the at least one network client, the lookup service means including a reference to the at least one network service.

2. The host computer according to claim 1, wherein the data processing system includes a lookup service comprising information associated with the at least one network service, and the lookup service interface means comprises an interface object which is configured to facilitate non-proxy communication with the lookup service.

3. The host computer according to claim 2, wherein the lookup service interface means is configured to maintain a communications link with the lookup service and to register with the lookup service over the communications link a client service hosted by the at least one network client.

4. The host computer according to claim 2 or 3, wherein the data processing system includes a storage means and the lookup service interface means is configured to register the client service by transmitting to the storage means one of an object: defining the client service and a proxy to the client service.

5. The host computer according to claim 4, wherein the lookup service interface means is configured to serialize the object prior to the transmission, and the data processing system is configured to retain the serialized object in the storage means in serialized form.

6. The host computer according to any of claims 2 to 4, wherein the lookup service is configured to provide the lookup service interface means with a notification indicating registration with the lookup service of a client service hosted by another of the network clients.

7. The host computer according to claim 6, wherein the lookup service interface means is configured to notify the at least one client of the registration of another network client.

8. The host computer according to claim 2, wherein the lookup service interface means is configured with a register method for registering with the lookup service a client service hosted by the at least one network client, the register method comprising the steps of updating the lookup service interface means to include a client service reference to the client service, and notifying the lookup service of the client service reference.

9. The host computer according to claim 8, wherein the updating step comprises the steps of inserting in the lookup service interface means the client service reference if the lookup service interface means does not already include the client service reference, and updating the client service reference if the lookup service interface means already includes the client service reference.

10. The host computer according to claim 2, wherein the lookup service interface means is configured with a lookup method for locating within the reference an entry matching a template.

11. The host computer according to any of claims 1 to 10, wherein the data processing system includes a Java Virtual Machine, and is configured to marshall the lookup service interface means prior to the transmission to the at least one network client.

12. The host computer according to anti of claims 1 to 10, wherein the data processing system excludes a Java Virtual Machine, and is configured to receive a pre-marshalled one of the lookup service means.

13. A method for providing at least one network client with access to at least one network service in a distributed computing environment, the method comprising the steps of:
receiving at a host computer an access request to a lookup service from the at least one network client; and
transmitting lookup service interface means to the at least one network client, the lookup service means including a reference to the at least one network service.

14. The method according to claim 13, wherein the host computer includes a hookup service comprising information associated with the at least one network service, and the lookup service interface means is configured to facilitate non-proxy communication with the lookup service.

15. The method according to claim 14, wherein the lookup service interface means maintains a communications link with the lookup service and registers with the lookup service over the communications link a client service hosted by the at least one network client.

16. The method according to claim 15, wherein the registering step comprises the lookup service interface means transmitting to the host one of an object defining the client service and a proxy to the client service.

17. The method according to claim 16, wherein the look-up service interface means serializes the object prior to the transmission to the host, and the data processing system retains the serialized object in the storage means in serialized form.

18. The method according to any of claims 14 to 17, wherein the lookup service provides the lookup service interface means with a notification indicating registration with the lookup service of a client service hosted by another of the network clients.

19. The method according to claim 18, wherein the lookup service interface means notifies the at least one client of the registration of the another network client.

20. The method according to claim 14, wherein the lookup service interface means is configured with a register method for registering with the lookup service a client service hosted by the at least one network client, the register method comprising the steps of updating the lookup service interface means to include a client service reference to the client service, and notifying the lookup service of the client service reference.

21. The method according to claim 19, wherein the updating step comprises the steps of inserting in the lookup service interface means the client service reference if the lookup service interface means does not already include the client service reference, and updating the client service reference if the lookup service interface means already includes the client service reference.

22. The method according to claim 14, wherein the lookup service interface means is configured with a lookup method for locating within the reference an entry matching a template.

23. The method according to any of claims 13 to 22, wherein the host computer includes a Java Virtual Machine, and marshalls the lookup service interface means prior to the transmission to the at least one network client.

24. The method according to any of claims 13 to 22, wherein the host computer excludes a Java Virtual Machine, and is receives a pre-marshalled one of the lookup service means.

25. A computer-readable medium including processing instructions for a general purpose computer, the processing instructions defining in the computer a data processing system for interfacing the computer with a network; the data processing system being configured to transmit lookup service interface means over the network to at least one network client, the lookup service means including a reference to at least one network service available over the network.

26. The computer-readable medium according to claim 25, wherein the data processing system includes a lookup service comprising information associated with the at least one network service, and the lookup service interface means comprises an interface object which is configured to facilitate non-proxy communication with the lookup service.

27. The computer-readable medium according to claim 26, wherein the lookup service interface means is configured to maintain a communications link with the lookup service and to register with the hookup service over the communications link a client service hosted by the at least one network client.

28. The computer-readable medium according to claim 26 or 27, wherein the data processing system includes a storage means, and the lookup service interface means is configured to register the client service by transmitting to the storage means one of an object defining the client service and a proxy to the client service.

29. The computer-readable, medium according to any of claims 26 to 28, wherein the lookup service is configured to provide the lookup service interface means with a notification indicating registration with the lookup service of a client service hosted by another of the network clients.

30. The computer-readable medium according to claim 29, wherein the lookup service interface means is configured to notify the at least client of the registration of the another network client.

31. The computer-readable medium according to claim 26, wherein the lookup service interface means is configured with a register method for registering with the lookup service a client service hosted by the at least one network client, the register, method comprising the steps of updating the lookup service interface means to include a client service reference to the client service, and notifying the lookup service of the client service reference.

32. The computer-readable medium according to claim 31, wherein the updating step comprises the steps of inserting in the lookup service interface means the client service reference if the lookup service interface means does not already include the client service reference, and updating the client service reference if the lookup service interface means already includes the client service reference.

33. The computer-readable medium according to claim 26, wherein the lookup service interface means is configured with a lookup method for locating within the reference an entry matching a template.

34. The computer-readable medium according to claim 26, wherein the reference includes an attribute set comprising at least one attribute associated with the at least one network service, and the lookup service interface means is configured with a modify method for modifying the at least one attribute, the modify method comprising the steps of modifying the attribute set within the lookup service interface means; and notifying the lookup service of the attribute set modification.

35. An electronic signal defining lookup service interface means in a client computer interfacing with a computer network, the lookup service means including a reference to at least one network service available over the network.

36. The electronic signal according to claim 35, wherein the lookup service interface means is configured to maintain a communications link with a lookup service and to register with the lookup service over the communications link a client service hosted by the client computer, the lookup service comprising information associated with the at least one network service.

37. The electronic signal according to claim 35 or 36, wherein the lookup service interface means is configured to provide the client computer with a notification indicating registration with the lookup service of a client service hosted by another client computer.

38. The electronic signal according to claim 36, wherein the lookup service interface means is configured with a register method for registering with the lookup service a client service hosted by the client computer, the register method comprising the steps of updating the lookup service interface means to include a client service reference to the client service, and notifying the-lookup service of the client service reference.

39. The electronic signal according to claim 38, wherein the updating step comprises the steps of inserting in the lookup service interface means the client service reference if the lookup service interface means does not already include the client service reference, and updating the client service reference if the lookup service interface means already includes the client service reference.

40. The electronic signal according to claim 36, wherein the lookup service interface means is configured with a lookup method for locating within the reference an entry matching a template.

41. A host computer for providing at least one network client with access to at least one network service in a distributed computing environment, the host computer comprising:
a network interface for interfacing the host computer with the network; and
a data processing system in communication with the network interface; the data processing system including a lookup service comprising information associated with the at least one network service, the data processing system being configured to transmit lookup service interface means to the at least one network client, the lookup service means comprising an interface object which is configured to facilitate non-proxy communication with the lookup service.

42. The host computer according to claim 41, wherein the lookup service interface means includes a reference to the at least one network service.

43. The host computer according to claim 41, wherein the lookup service interface means is configured with a register method for registering with the lookup service a client service hosted by the at least one network client, the register method comprising the steps of updating the lookup service interface means to include a client service reference to the client service, and notifying the lookup service of the client service reference.

44. The host computer according to claim 43, wherein the updating step comprises the steps of inserting in the lookup service interface means the client service reference if tie lookup service interface means does not already include the client service reference, and updating the client service reference if the lookup service interface means already includes the client service reference.

45. The host computer according to claim 41, wherein the lookup service interface means is configured with a lookup method for locating within the reference an entry matching a template.

46. The host computer according to claim 41, wherein the reference includes an attribute set comprising at least one attribute associated with the at least one network service, and the lookup service interface means is configured with a modify method for modifying the at least one attribute, the modify method comprising the steps of modifying the attribute set within the lookup service interface means; and notifying the lookup service of the attribute set modification.

47. A method for providing at least one network client with access to at least one network service in a distributed computing environment, the method comprising the steps of:
receiving at a host computer an access request to a lookup service from the at least one network client, the host computer including a lookup service comprising information associated with the at least one network service; and
transmitting lookup service interface means to the at least one network client, the lookup service means being configured for non-proxy communication with the lookup service.

48. The method according to claim 47, wherein the lookup service interface means includes a reference to the at least one network service.

49. The method according to claim 47, wherein the lookup service interface means is configured with a register method for registering with the lookup service a client service hosted by the at least one network client, the register method comprising the steps of updating the lookup service interface means to include a client service reference to the client service, and notifying the lookup service of the client service reference.

50. The method according to claim 49, wherein the updating step, comprises the steps of inserting in the lookup service interface means the client service reference if the lookup service interface means does not already include the client service reference, and updating the client service reference if the lookup service interface means already includes the client service reference.

51. The method according to claim 47, wherein the lookup service interface means is configured with a lookup method for locating within the reference an entry matching a template.

52. The method according to claim 47, wherein the reference includes an attribute set comprising at least one attribute associated with the at least one network service, and the lookup service interface means is configured with a modify method for modifying the at least one attribute, the modify method comprising the steps of modifying the attribute set within the lookup service interface means; and notifying the lookup service of the attribute set modification.
